(19) United States
(12) Patent Application Publication
(10) Pub. No.: US 2012/0151174 A1
(43) Pub. Date: Jun. 14, 2012

(54) COMPUTER SYSTEM, MANAGEMENT METHOD OF THE COMPUTER SYSTEM, AND PROGRAM

(75) Inventors: Naoyuki Matsunaga, Yokohama (JP); Takato Kusama, Yokohama (JP)

(73) Assignee: Hitachi, Ltd.

(21) Appl. No.: 13/061,894

(22) PCT Filed: Dec. 13, 2010
(86) PCT No.: PCT/JP2010/072377

§ 371 Date: Mar. 2, 2011

(51) Int. Cl. G06F 12/00

(52) U.S. Cl. 711/171; 711/E12.002

(57) ABSTRACT

Provided is a pool capacity monitoring technique capable of appropriately predicting timing of pool capacity depletion even if there is a change in the external environment, such as an addition of a new application and a characteristic change in an existing application. In the present invention, consumption of each medium comprising a pool is predicted every time there is a change in the external environment, such as an addition of an application, to predict the capacity depletion timing of the pool, and the prediction of the capacity depletion period is recalculated. A predicted value of I/O consumption patterns of each application using a virtual volume is calculated for each medium from past consumption patterns stored in a storage.

### TECHNICAL FIELD

The present invention relates to a computer system, a management method of the computer system, and a program, and for example, to a technique for recognizing a capacity of a storage pool comprising a plurality of storage areas of one or more media (storage devices).

### BACKGROUND ART

The number of data held by companies is continuously increasing along with the introduction of IT in various operations in recent years. Under the circumstances, storage integration by SAN (Storage Area Network) is being widely used.

Thin Provisioning is focusing attention as a technique for reducing the storage management cost. The Thin Provisioning is a technique in which a storage allocates virtual volumes to a host and dynamically and gradually allocates disk capacities in the storage to the virtual volumes in accordance with an I/O request from the host. As a result, disks can be gradually enhanced based on the use status (specifically, size of the disk used) of the storage of the host without purchasing the disks in advance for all volumes allocated to the host. In relation to the Thin Provisioning, there is a method of establishing pools comprising a plurality of disks in the storage, creating virtual volumes to be allocated to the host from the pools, and dynamically allocating the disks in the pools along with an I/O request to the virtual volumes from the host computer. In this case, the pools need to be managed. More specifically, free capacities of the pools need to be periodically monitored to prevent an I/O error due to capacity depletion of the pools.

Furthermore, the Thin Provisioning can be extended to comprise the pools by a combination of disks with different physical characteristics (for example, SSD and SATA disks), data with high I/O frequency can be arranged in a high-speed disk (for example, SSD), and data with low I/O frequency can be arranged in a low-speed disk (for example, SATA). The free capacities of the pools also need to be monitored as in the case of the Thin Provisioning.

### CITATION LIST

### Patent Literature

Patent Literature 1: JP Patent Publication (Kokai) No. 2003-216460A

### SUMMARY OF INVENTION

### Technical Problem

In a conventional pool capacity monitoring technique (conventional method) in the Thin Provisioning, future consumption patterns are predicted from past capacity consumption patterns of the pools to predict capacity depletion timing of the pools, and a period of the capacity depletion is predicted.

However, changes in the external environment are not taken into consideration in the conventional method. More specifically, the future consumption patterns are predicted based only on the past capacity consumption patterns of the pools in the conventional method, and a change in the pool capacity consumption patterns due to a configuration change in volume allocation from an existing pool to a new application, etc., cannot be predicted.

Furthermore, the history needs to be acquired until the pool capacity consumption patterns of a new volume can be predicted in order to predict a change in the pool capacity consumption patterns due to a configuration change in the conventional method, and the pool capacity depletion timing cannot be recognized at a timing of the addition of the volume.

The present invention has been made in view of the circumstances, and the present invention provides a pool capacity monitoring technique capable of appropriately predicting timing of pool capacity depletion even if there is a change in the external environment, such as an addition of a new application and a characteristic change in an existing application.

### Solution to Problem

To solve the problems, consumption of each medium comprising a pool is predicted every time there is a change in the external environment, such as an addition of an application, to predict capacity depletion timing of the pool, and the prediction of the capacity depletion period is recalculated. A predicted value of I/O consumption patterns of each application using a virtual volume is calculated for each medium from past consumption patterns stored in a storage.

More specifically, a computer system according to the present invention comprises a storage subsystem that provides storage areas of one or more physical storage devices to a host computer as a virtual volume and a management computer that manages the storage subsystem. The management computer responds to an input instruction of allocation of the virtual volume that should be used by an application to acquire information related to past consumption capacity patterns of a virtual volume used by an application of the same or similar application type as the application and predicts a consumed capacity in the virtual volume to be allocated based on the information related to the consumption capacity patterns.

### Advantageous Effects of Invention

According to the present invention, timing of pool capacity depletion can be appropriately predicted even if there is a change in the external environment, such as an addition of a new application and a characteristic change in an existing application.

Other problems, configurations, and effects will be apparent from the following description of an embodiment and the attached drawings.

### BRIEF DESCRIPTION OF DRAWINGS

FIG. 1 is a diagram showing a schematic configuration of a computer system according to an embodiment of the present invention.

FIG. 2 is a diagram showing an internal configuration of a host computer.

FIG. 3 is a diagram showing an internal configuration of a storage subsystem.

FIG. 4 is a diagram showing an example of configuration of a RAID group management table.

FIG. 5 is a diagram showing an example of configuration of a real area management table.

FIG. 6 is a diagram showing an example of configuration of a virtual volume (VVOL) management table.

FIG. 7 is a diagram showing an example of configuration of a tier definition table.

FIG. 8 is a diagram showing an example of configuration of a pool-virtual volume (VVOL) correspondence management table.

FIG. 9 is a diagram showing an internal configuration of a management computer.

FIG. 10 is a diagram showing an example of configuration of a mapping table showing a correspondence between application names, application types, and virtual volume IDs.

FIG. 11 is a diagram showing an example of configuration of a virtual volume capacity information table.

FIG. 12 is a diagram showing an example of configuration of a pool capacity prediction table.

FIG. 13 is a diagram for explaining an overall summary of a process in the computer system.

FIG. 14 is a diagram showing an example of configuration of an application information input screen (GUI).

FIG. 15 is a diagram showing an example of configuration of a tier management table configuration screen (GUI).

FIG. 16 is a diagram showing an example of configuration of a pool capacity prediction result report screen.

FIG. 17 is a flow chart for explaining a rearrangement process.

FIG. 18 is a flow chart for explaining a summary of a process executed by the management computer.

FIG. 19 is a flow chart for explaining details of processing of a Page allocation prediction engine for new VOL during addition of an application.

FIG. 20 is a flow chart for explaining a summary of processing of a Page allocation prediction engine for existing VOL.

FIG. 21 is a flow chart for explaining details of a predicted capacity consumption calculation process (step 2001) of each Tier of a pool.

FIG. 22 is a flow chart for explaining details of a capacity consumption calculation process (step 2002) of each Tier of a pool.

FIG. 23 is a diagram showing an example of configuration of an application deletion screen (GUI).

FIG. 24 is a diagram showing an example of configuration of a charge configuration screen (GUI) of each Tier.

FIG. 25 is a diagram showing an example of configuration of a charge management table of each Tier.

FIG. 26 is a diagram showing an example of configuration of a pool capacity prediction result report screen.

### DESCRIPTION OF EMBODIMENTS

Hereinafter, an embodiment of the present invention will be described with reference to the attached drawings. However, it should be noted that the present embodiment is just an example for realizing the present invention and that the embodiment does not limit the technical scope of the present invention. Common configurations in the drawings are designated with the same reference numerals.

Although information of the present invention will be expressed as “aaa table” in the following description, the information may not be necessarily expressed by a data structure of a table, and the information may be expressed by a data structure of a list, a DB, a queue, or the like or may be expressed in other ways. Therefore, “aaa table”, “aaa list”, “aaa DB”, “aaa queue”, and the like may be called “aaa information” to show that the information is independent of the data structure.

Expressions such as “identification information”, “identifier”, “forename”, “name”, and “ID” can be used to describe the content of the information, and the expressions can replace each other.

Although “program”, “engine”, and “agent” serve as subjects in the following description, a processor executes the program and the like to execute a defined process while using a memory and a communication port (communication control apparatus). Therefore, the processor may serve as a subject in the description. A disclosed process with a program as a subject may be a process executed by a computer, such as a management server, or an information processing apparatus. Part or all of the programs may be realized by dedicated hardware or may be realized by modules. Various programs may be installed in each computer by a program distribution server or by storage media.

### <Configuration of Computer System>

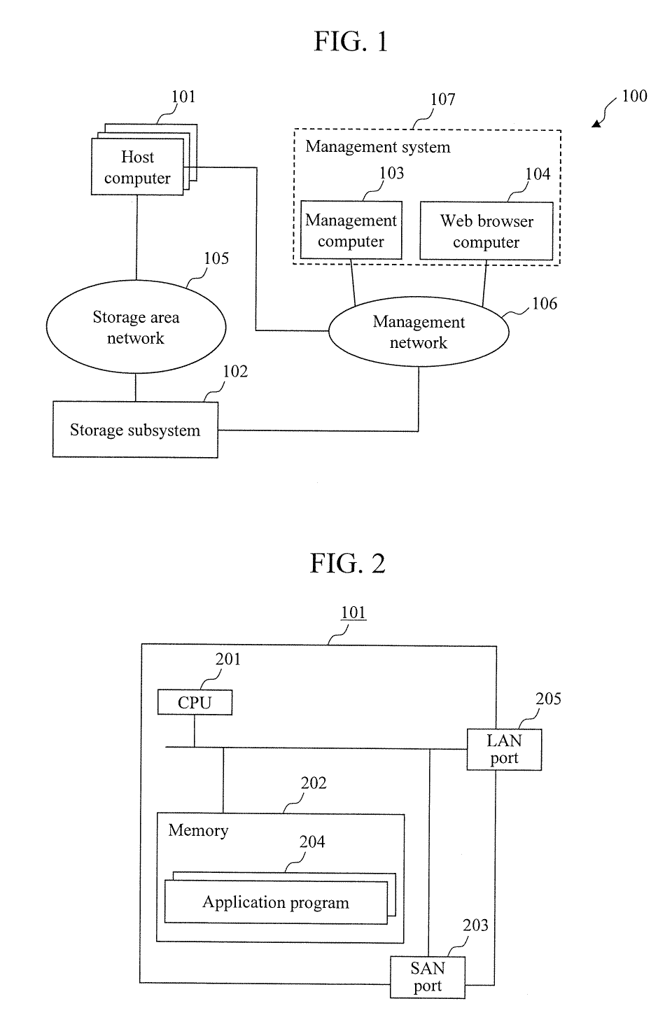

FIG. 1 is a diagram showing a schematic configuration of a computer system 100 according to the embodiment of the present invention. The computer system 100 comprises a host computer 101, a storage subsystem 102, and a management system 107. The storage subsystem 102 and the host computer 101 are connected through a storage area network 105. The management system 107, the storage subsystem 102, and the host computer 101 are connected through a management network 106.

The management system 107 includes a management computer 103 and a Web browser computer 104. The management computer 103 and the Web browser computer 104 may be the same computer, or a plurality of computers may realize identical functions. The management system 107 transmits a control request to the storage subsystem 102 through the management network 106.

The host computer 101 transmits an access request to the management system 107 through the management network 106.

The storage subsystem 102 receives a control request from the management system 107 through the management network 106 to execute a process according to the request. A plurality of host computers 101, storage subsystems 102, and management systems 107 may be installed in the present computer system 100.

### <Configuration of Host Computer>

FIG. 2 is a diagram showing an internal configuration of the host computer 101. The host computer 101 comprises a SAN port 203 for realizing connection with the storage area network 105, a LAN port 205 for realizing connection with the management network 106, a memory 202, and a CPU 201 connected to the memory 202, the SAN port 203, and the LAN port 205.

The SAN port 203 is connected to the storage area network 105. The LAN port is connected to the management network 106.

The memory 202 stores one or more application programs 204. The application programs 204 are executed by the CPU 201 to transmit access requests to the storage subsystems 102 through the LAN port 205 and the management network 105.

### <Configuration of Storage Subsystem>

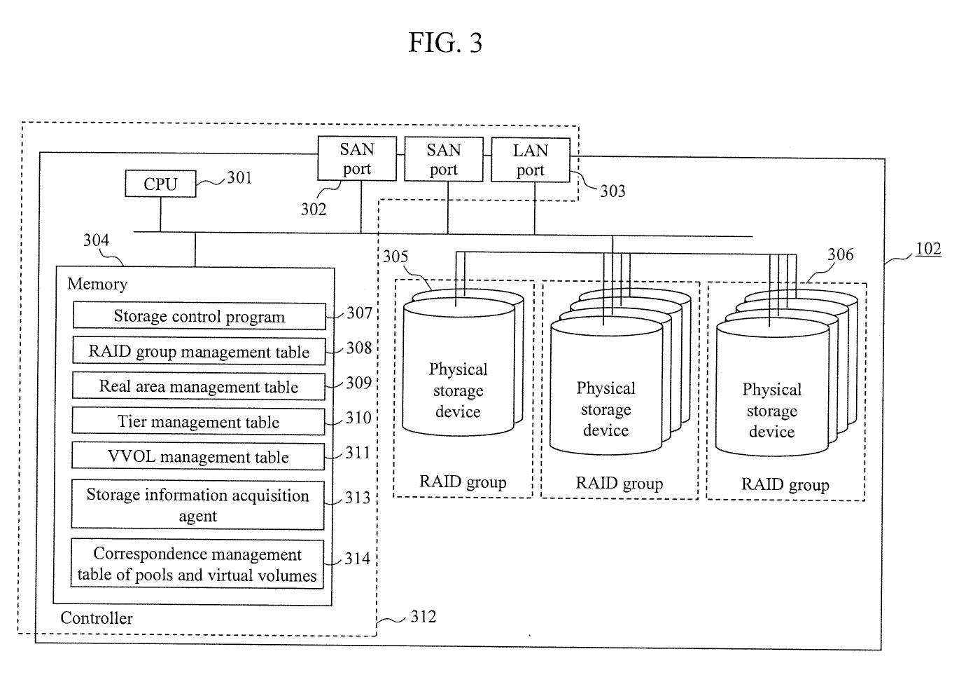

FIG. 3 is a diagram showing an internal configuration of the storage subsystem 102. The storage subsystem 102 includes a plurality of physical storage devices 305 with different physical characteristics, such as the number of disk rotations, and a controller 312, and the physical storage devices 305 and the controller 312 are interconnected through a circuit, such as an internal bus. If there are a plurality of physical storage devices 305 of the same type, the devices may form a RAID configuration. The plurality of physical storage devices 305 that form a RAID configuration comprise RAID groups 306.

The controller 312 includes at least one SAN port 302 for connection with the storage area network 105, at least one LAN port 303 for connection with the management network 106, a memory 304, and a CPU 301 connected to the components.

The SAN port 302 is a port connected to the storage area network 105. The SAN port 302 receives an access request from the host computer 101.

The LAN port 303 is a port connected to the management network 106. The LAN port 303 receives a control request from the management system 107.

The memory 304 stores a storage control program 307, a RAID group management table 308, a real area management table 309, a tier management table 310, a VVOL management table 311, a storage information acquisition agent 313, and a pool-virtual volume correspondence management table 314.

The storage information acquisition agent 313 is a program for which the controller 312 in the storage subsystem 102 acquires information of allocation capacity of each Tier for each VOL from the storage subsystem 102. The information to be acquired will be described later.

The storage control program 307 is executed by the CPU 301 to execute an access control process enabling access to a virtual volume described below, a data writing process, and a rearrangement process only for the designated management system 107.

The storage control program 307 executes the data writing process as follows. More specifically, when a data writing request is received from the host computer 101, the storage control program 307 specifies a virtual area at a destination of data writing (hereinafter, “writing destination virtual area”) based on access destination information included in the data writing request.

Next, the storage control program 307 determines whether a real area is allocated to the writing destination virtual area. Specifically, the storage control program 307 determines whether the writing destination virtual area is registered in the VVOL management table 311.

If a real area is allocated to the writing destination virtual area, the storage control program 307 writes writing target data in the real area allocated to the writing destination virtual area. If a real area is not allocated to the writing destination virtual area, the storage control program 307 determines whether there is an unallocated real area to be allocated to the writing destination virtual area. Specifically, the storage control program 307 determines whether there is a real area in which an allocation status 504 of the real area management table 309 is “unallocated”.

If there is an unallocated real area in the writing destination virtual area, the storage control program 307 allocates the unallocated real area to the writing destination virtual area and writes the writing target data in the real area.

If there is no unallocated real area in the writing destination virtual area, the storage control program 307 transmits an error to the host computer 101.

The storage control program 307 also determines whether the writing destination virtual area is a constituent element of a pool. If the writing destination virtual area is a constituent element of a pool, the storage control program 307 writes values of a set of a pool ID 2302 as an identifier of the pool and a VVOL ID 2301 as an identifier of a virtual volume in a correspondence management table 2301 of pools and virtual volumes.

Lastly, the storage control program 307 updates the value of the number of accesses 604 corresponding to the writing source virtual area.

### <Method of Realizing Virtual Volume>

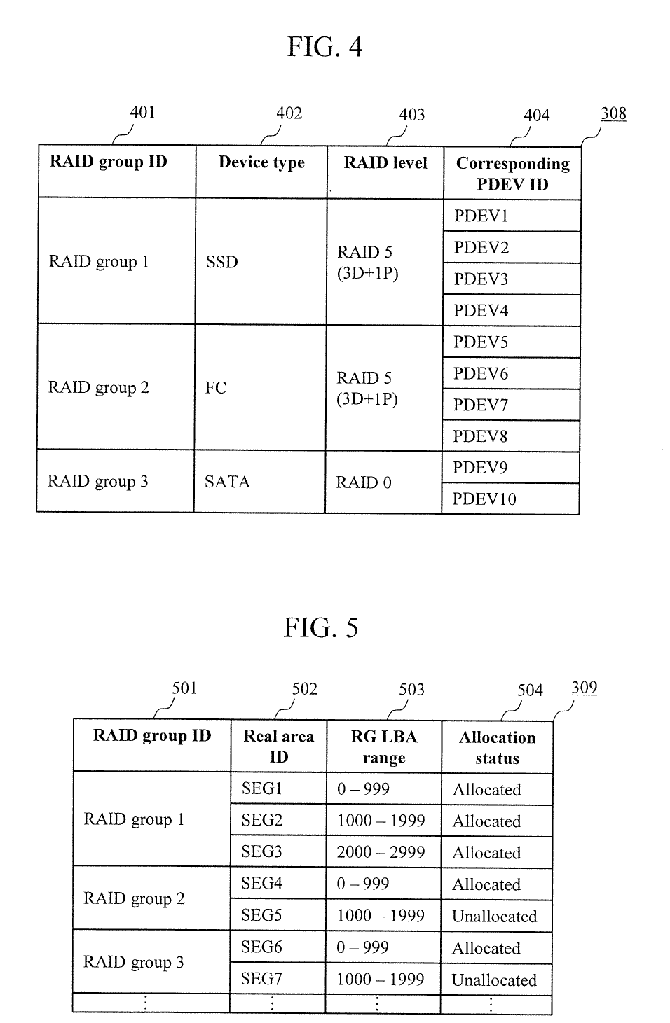

The storage control program 307 establishes RAID groups from a plurality of physical storage devices as shown in FIG. 4 described later. Upon allocation of a virtual volume designated from the host computer 101, the storage control program 307 does not allocate a physical disk corresponding to the volume size to the host computer 101, but dynamically allocates the physical disk according to the use status of volume. Hereinafter, the volume will be called a virtual volume (also called “VVOL”).

In a method of realizing the virtual volume, the storage control program 307 first divides each RAID group into a fixed size (for example, 1000 blocks). Hereinafter, the divided unit will be called a segment. The storage control program 307 also recognizes the allocation status of each segment as shown in FIG. 5 described later and uses an unallocated segment to allocate a new segment to a virtual volume.

The rearrangement process executed by the storage control program 307 will be described later.

### <RAID Group Management Table 308>

FIG. 4 is a diagram showing an example of configuration of the RAID group management table 308 included in the storage subsystem 102. The RAID group management table 308 includes information related to the performance of the RAID groups 306.

For example, the RAID group management table includes, as configuration items, a RAID group ID 401 indicating an identifier of a RAID group, a device type 402 indicating a type of a physical storage device forming the RAID group, a RAID level 403 indicating a RAID level and a combination of the RAID group, and a PDEV_ID 404 indicating an identifier of the physical storage device forming the RAID group. Other types of information may be included in place of or in addition to at least one of the information 401 to 404.

### <Real Area Management Table 309>

FIG. 5 is a diagram showing an example of configuration of the real area management table 309 included in the storage subsystem 102. The real area management table 309 includes information indicating whether the real areas included in the RAID groups 306 are allocated to the virtual volumes.

For example, the real area management table 309 includes, as configuration items, a RAID group ID 501 indicating an identifier of RAID group including a real area, a real area ID 502 indicating an identifier of the real area, a RG LBA ranges 503 indicating an LBA range of the RAID group corresponding to the real area, and the allocation status 504 indicating whether the real area is allocated.

### <VVOL (Virtual Volume) Management Table 311>

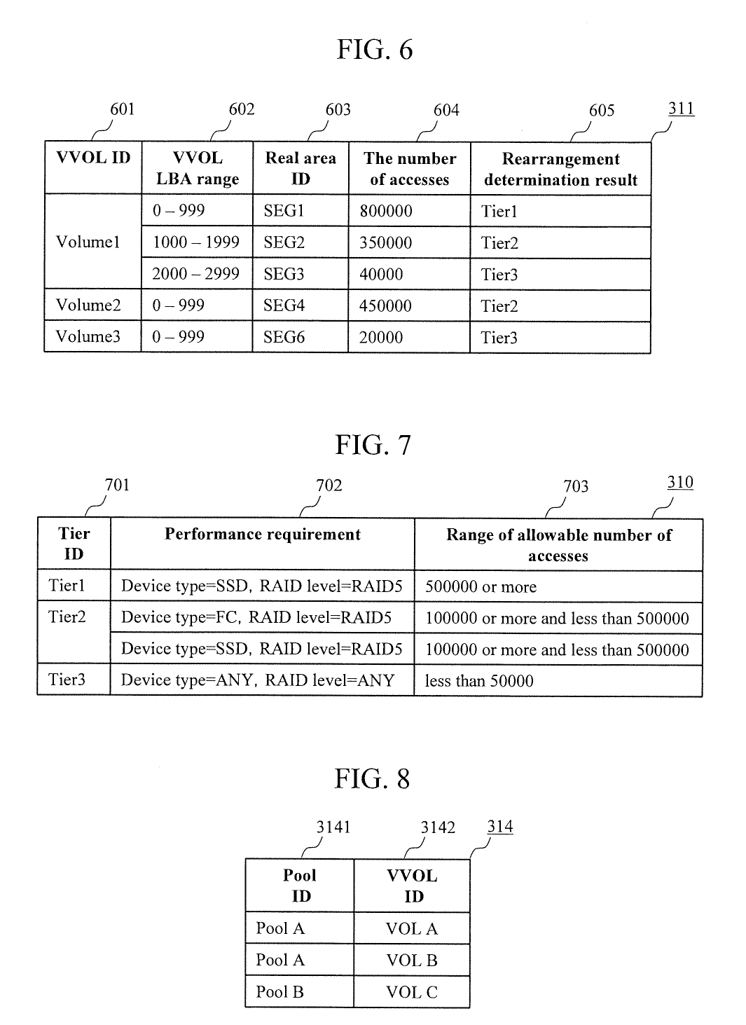

FIG. 6 is a diagram showing an example of configuration of the VVOL management table 311 included in the storage subsystem 102. The VVOL management table 311 includes information related to virtual areas in the virtual volumes and real areas allocated to the virtual areas.

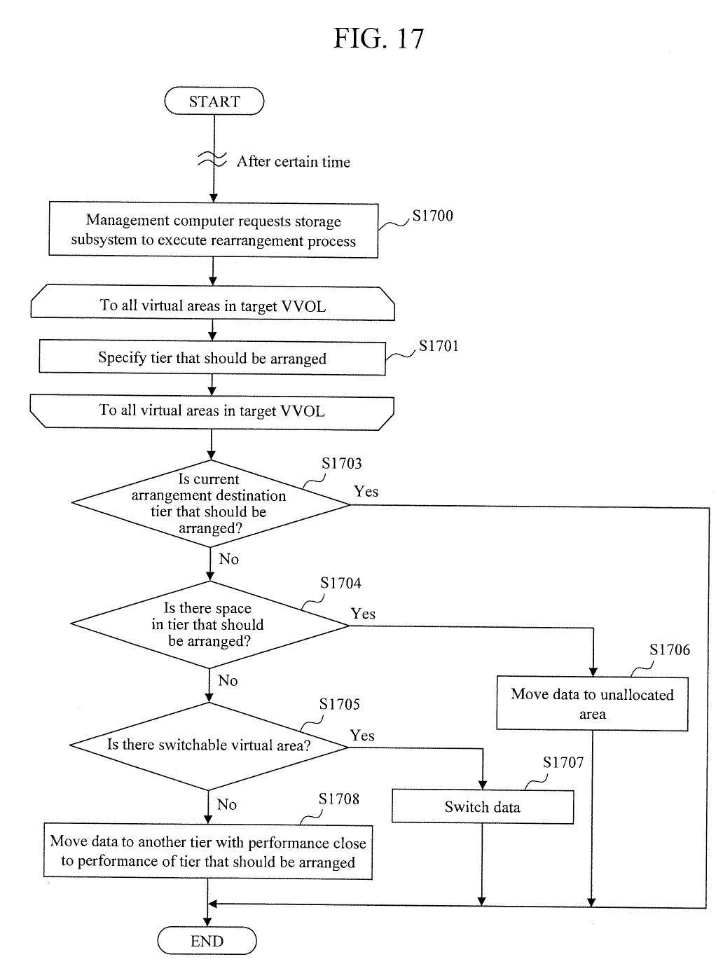

For example, the VVOL management table 311 includes, as configuration items, a VVOL ID 601 indicating an identifier of a virtual volume, a VVOL LBA range 602 indicating an LBA range corresponding to a virtual area in a virtual volume, a real area ID 603 indicating a real area allocated to the virtual area in the virtual volume, the number of accesses 604 indicating the number of accesses (number of total I/Os in a certain period) from the host computer 101 to the virtual area in the virtual volume, and a rearrangement determination result 605 indicating an identifier of a tier for which it is determined that the real area in the tier should be allocated to the virtual area in the virtual volume in the rearrangement process described later (see FIG. 17).

In the VVOL management table 311, the VVOL_ID 601 is not an identifier designated from the host computer 101, but is information indicating an identifier recognized in the storage subsystem 102. The number of accesses 604 includes a value of the number of accesses to the virtual area, and the storage subsystem 102 resets the value of the number of accesses 604 to 0 every predetermined time, such as every 24 hours. The storage control program 307 monitors the allowable number of accesses of Tier, and the result determined based on a value of a range of allowable number of accesses 703 of the tier management table 310 shown in FIG. 7 is stored in the rearrangement determination result 605.

The rearrangement determination result 605 in FIG. 6 shows information of a determination result in a state after the execution of rearrangement determination but before the execution of the rearrangement process. Therefore, it should be noted that the information of the tier indicated by the rearrangement determination result 605 and the tier, to which the device including the area indicated by the real area ID 603 belongs, do not match. The pieces of information match immediately after the execution of the rearrangement process.

### <Tier Definition Table 310>

FIG. 7 is a diagram showing an example of configuration of the tier definition table 310 included in the storage subsystem 102. The tier definition table 310 includes information related to the performance of tiers and the range of allowable number of accesses.

For example, for each tier, the tier definition table 310 includes, as configuration items, a tier ID 701 indicating an identifier of the tier, a performance requirement 702 indicating a performance requirement of the tier, and an allowable IOPS range 703 indicating a range of allowable number of accesses per unit time corresponding to the tier. In the tier definition table 310, the performance requirement 702 of tier is defined by, for example, the type of the physical storage device and the RAID level of RAID group.

Each tier 701 identified by the tier ID includes, as an element, a real area belonging to a physical storage device and/or a RAID group satisfying the performance requirement 702.

The tier definition table 310 is set to the tier management table 310 of the memory 304 of the LAN port 303 of the storage subsystem 102 through the management network in accordance with a request from the management computer 103 or the host computer 101.

### <Pool-Virtual Volume Correspondence Management Table 314>

FIG. 8 is a diagram showing an example of configuration of the pool-virtual volume (VVOL) correspondence management table 314 that manages the correspondence between pools and virtual volumes.

For example, the pool-virtual volume correspondence management table 314 includes, as configuration items, a pool ID 3141 and a VVOL_ID 3142.

A virtual volume included in each pool can be recognized from the pool-virtual volume correspondence management table 314. For example, a pool A comprises virtual volumes (VVOL) A and B. The information is acquired by the storage control program 307 and is used in a necessary process.

### <Configuration of Management Computer>

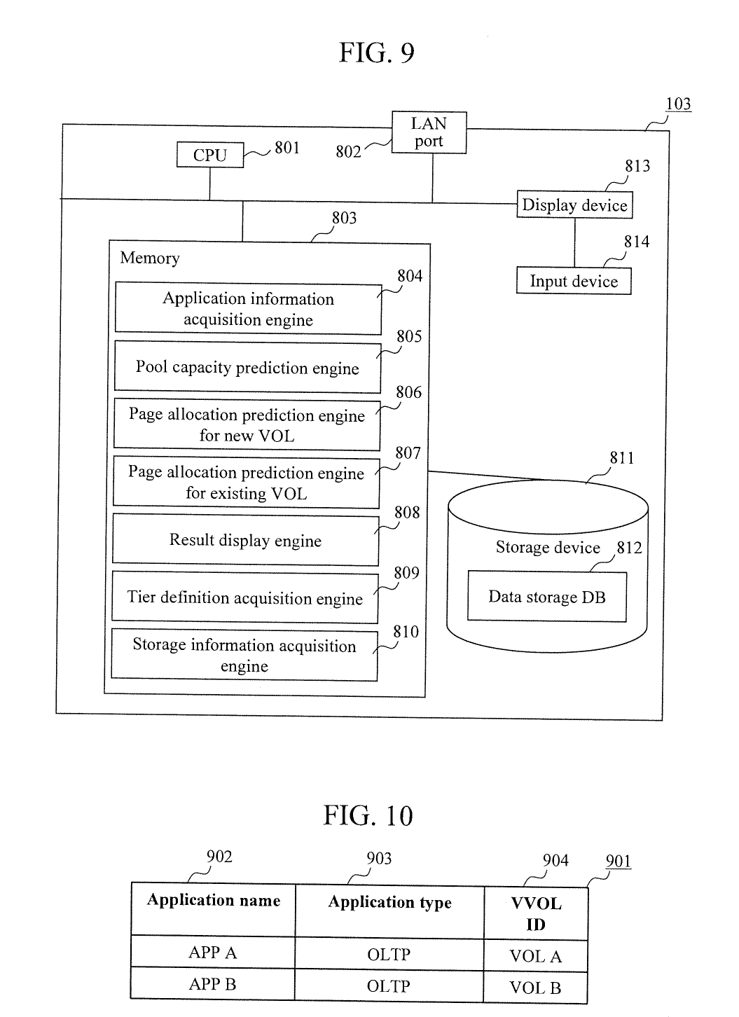

FIG. 9 is a block diagram showing an internal configuration of the management computer 103. The management computer 103 includes a LAN port 802 for connection with the management network 106, a CPU 801 that executes a configuration management program 804, and a memory 803 used by the CPU 801, and the components are interconnected through a circuit such as an internal bus.

The memory 803 stores an application information acquisition engine 804, a pool capacity prediction engine 805, a Page allocation prediction engine for new VOL 806, a Page allocation prediction engine for existing VOL 807, a result display engine 808, a Tier definition acquisition engine 809, and a storage information acquisition engine 810. The “engine” denotes a program for issuing a request to acquire desired information, and unless otherwise particularly stated, the “engine” may be reread as a “program”.

The management computer 103 includes a storage device 811, a display device 813, and an input device 814. The storage device 811 includes a data storage DB 812.

Although examples of an input device 400 included in a management computer 50 include a keyboard and a pointer device, other devices may be used. Other output devices (for example, a printer) may also be arranged in place of or in addition to the display device 401.

A serial interface or an Ethernet interface may serve as an input/output device in place of the input device and the display device (output device). A computer for display including a display, a keyboard, or a pointer device may be connected to the interface to transmit information for display to the computer for display or to receive information for input from the computer for display. In this way, the computer for display may display the information or receive an input to replace the input and the display by the input/output device.

Hereinafter, an assembly of one or more computers that manage the computer system 100 and that display the information for display of the present invention will be occasionally called a management system. The management computer 103 serves as the management system 107 if the management computer 103 displays the information for display, and a combination of the management computer 103 and the Web browser computer (computer for display) 104 also serves as the management system 107. A plurality of computers may realize the same processes as the processes by a management computer in order to speed up or improve the reliability of the management processes. In that case, the plurality of computers (including the computer for display if the computer for display displays the information) serve as the management system 107.

### (i) Application Information Acquisition Engine

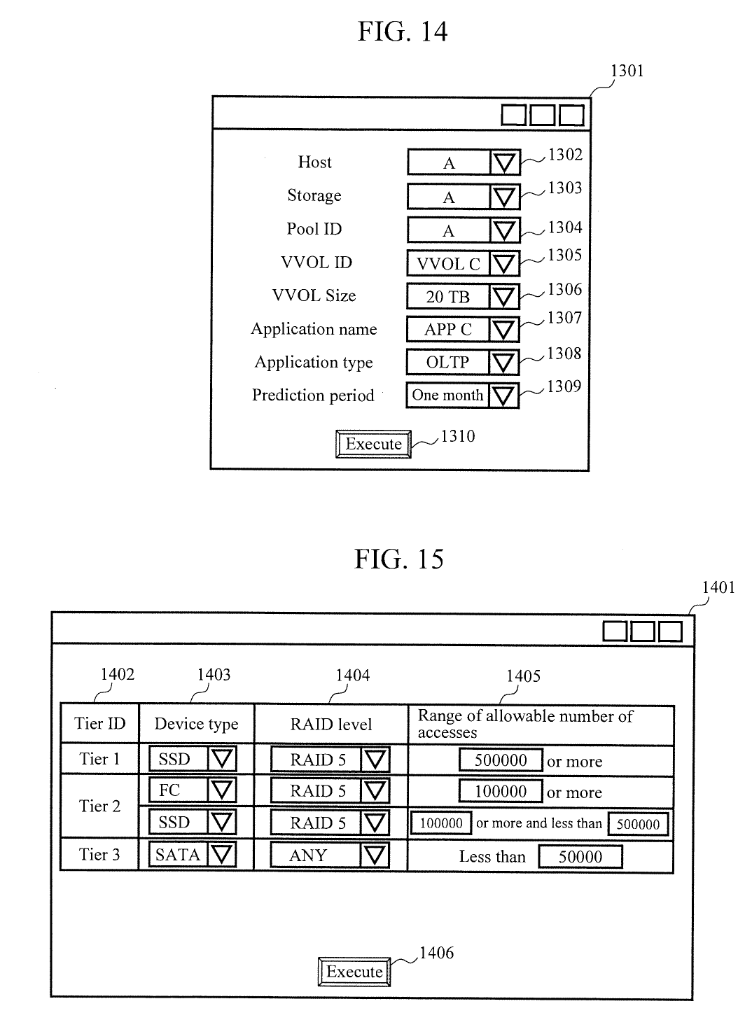

The application information acquisition engine 804 acquires a correspondence between a VOL and an application that are inputted on an application information input screen 1301 (see FIG. 14) and that are to be allocated by the user and stores the correspondence in a mapping table 901 of applications and volumes in the data storage DB of the storage device of the management computer 103. The mapping table 901 is included in the data storage DB 812.

The application information acquisition engine 804 acquires information of a newly added application name, an application type, and a virtual volume inputted from the input screen 1301 and stores the information in the mapping table 901 (see FIG. 10).

As shown in FIG. 10, the mapping table 901 includes, as configuration items, an application name 902, an application type 903, and a virtual VOL_ID 904. Checking the table allows recognizing what kind of application is allocated to which virtual volume.

The volume (VOL) to be allocated may be allocated to the host computer 101 as an extension of the process of the application information acquisition engine 804. The VOL may be allocated just after the input of an allocation instruction from the user, or the VOL to be allocated may be reserved to be allocated after a designated period instructed from the user.

### (ii) Tier Definition Acquisition Engine

The Tier definition acquisition engine 809 uses a tier management table configuration screen 1401 (see FIG. 15) to acquire information inputted by the user and stores the information in the tier management table 310 in the memory 304 of the storage subsystem 102 through the LAN port 802 of the management computer 103, the management network 106, and the LAN port 303 of the storage subsystem 102.

More specifically, for example, the Tier definition acquisition engine 809 collaborates with the storage control program 307 of the storage subsystem 102 to store, in the tier management table 310, a tier ID 1402 in the tier ID 701, a device type 1403 and a RAID level 1404 in the performance requirement 702, and a range of allowable number of accesses 1405 in the range of allowable number of accesses 703.

(iii) Storage Information Acquisition Engine

The CPU 801 of the management computer 103 periodically executes the storage information acquisition engine 810. During the execution, the storage information acquisition engine 810 acquires an allocation capacity of each Tier of each VVOL from the storage information acquisition agent 313 of the memory 304 of the storage subsystem 102. The storage information acquisition engine 810 then stores the acquired information in a virtual volume capacity information table 1001 in the data storage DB 812 through the LAN port 303, the management network 106, the LAN port 802, and the storage device 811.

More specifically, the storage information acquisition engine 810 stores the VVOL_ID 601 of the VOL management table 311 in a VVOLID 1004 of the virtual volume capacity information table 1001. The storage information acquisition engine 810 also stores a total capacity of the VVOL in a VVOL capacity 1005, information of utilization volumes of the Tiers of the VVOL in a Tier 1 utilization volume 1006, in a Tier 2 utilization volume 1007, and in a Tier 3 utilization volume 1008, and the time of data collection in collection time 1002. The storage information acquisition engine 810 further acquires a pool name, to which the VVOL belongs, from the pool ID 3141 of the pool-virtual volume correspondence management table 314 and stores the pool name in pool ID 1003.

### (iv) Pool Capacity Prediction Engine

The pool capacity prediction engine 805 is an engine that adds an application and a VVOL, allocates a Page to an existing VVOL, and predicts the capacity of the pool after the increase. Specifically, the pool capacity prediction engine 805 activates the Page allocation prediction engine for new VOL 806 and the Page allocation prediction engine for existing VOL 807 to add the values calculated by the Page allocation prediction engine for new VOL 806 and the Page allocation prediction engine for existing VOL 807 and stores the result in a pool capacity prediction table 1101 (see FIG. 12). Unlike the conventional Pool-by-Pool capacity prediction, the capacity is predicted for each Tier in the present embodiment.

### (v) Page Allocation Prediction Engine for New VOL

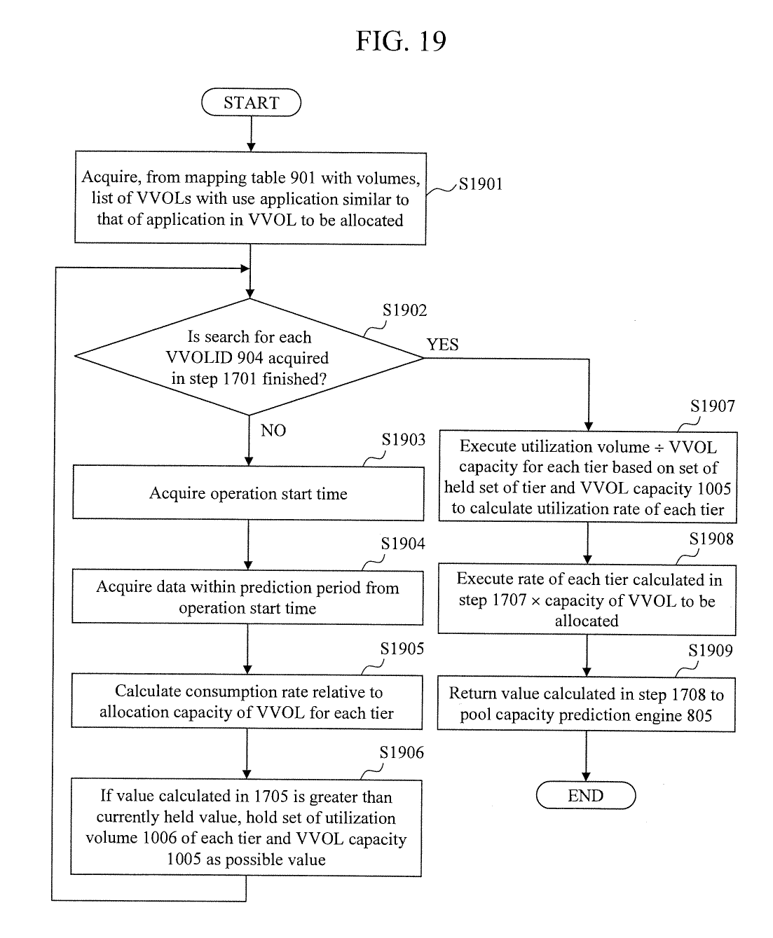

Based on information of an application name 1307, an application type 1308, and a prediction period 1309 of the application information input screen 1301, the Page allocation prediction engine for new VOL 806 specifies, from the mapping table 901 of applications and volumes, information of the same applications, the same type of applications, or applications with similar consumption patterns of volumes used by the applications (hereinafter, called “same or similar applications”) that are installed in the past. The Page allocation prediction engine for new VOL 806 then acquires, from the virtual volume capacity information table 1001, past capacity consumption patterns of VVOLs in a period designated in the prediction period 1309 from the start of the installation. The Page allocation prediction engine for new VOL 806 further calculates the utilization factor of each Tier from the capacity consumption patterns of VVOLs of the same or similar applications and returns the calculated values to the pool capacity prediction engine 805. The method of calculating the utilization factor of each Tier will be described later using FIG. 19.

### (vi) Page Allocation Prediction Engine for Existing VOL

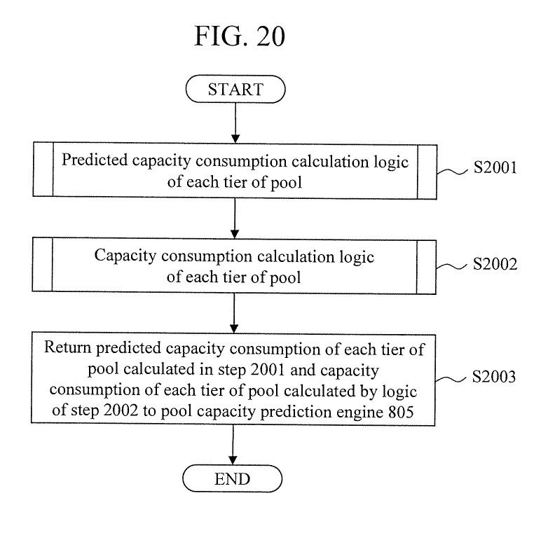

The Page allocation prediction engine for existing VOL 807 acquires, from the virtual volume capacity information table 1001, history information of the number of allocated Pages of each Tier in each pool managed by the storage subsystem 102 and uses a maximum likelihood estimation method (for example, least squares method) to predict the capacity consumption of the pool after the prediction period 1309 designated in the application information input screen 1301. The predicted calculation result is returned to the pool capacity prediction engine 805. The method of calculation will be described later using FIGS. 20 to 22.

(vii) Result Display Engine

A pool capacity prediction engine activates the result display engine 808. Data is acquired from the pool capacity prediction table 1101, and a pool capacity prediction result report screen 1501 is outputted to the display device 813.

### <Summary of Processing in the Present System>

The storage subsystem 102 according to the present embodiment periodically executes a process of collecting configuration information and capacity information of pools and virtual volumes provided by the storage subsystem 102 and a process of rearranging the Tier based on input information for performing tier management of the Tier designated by the user.

The pool comprises a plurality of tiers. The tiers are an assembly of real areas with the same performance. The tiers are defined by, for example, specific values indicating the performance and include real areas with the same performance as the performance indicated by the value. The tiers have a concept of high/low compared to other tiers. The height of the tiers depends on the height of the performance. The “performance” here is, for example, access performance and includes response time, data transfer speed, IOPS (the number of access requests processed per unit time), or the like. Examples of the access request include a write request and a read request.

Each tier comprises two or more real areas. Therefore, it can be stated that the pool comprises a plurality of real areas. The real area is part of the storage area of the physical storage device and/or the RAID group. The performance of the tier depends on the performance of the real areas forming the tier. The performance of the real area depends on, for example, the type of the physical storage device including the real area, the RAID level of the RAID group, and/or the number of storage devices participating in the RAID group. Examples of the type of the physical storage device include SSD, SAS-HDD, and SATA-HDD.

The virtual volume comprises a plurality of virtual areas (virtual storage areas). One or less real area is allocated to each virtual area. The real area may not be allocated to the virtual area. When a write request for the virtual area (unallocated virtual area) is received from the host computer, the storage subsystem 102 allocates the real area, which is not allocated to any virtual area (unallocated real area), to the virtual area.

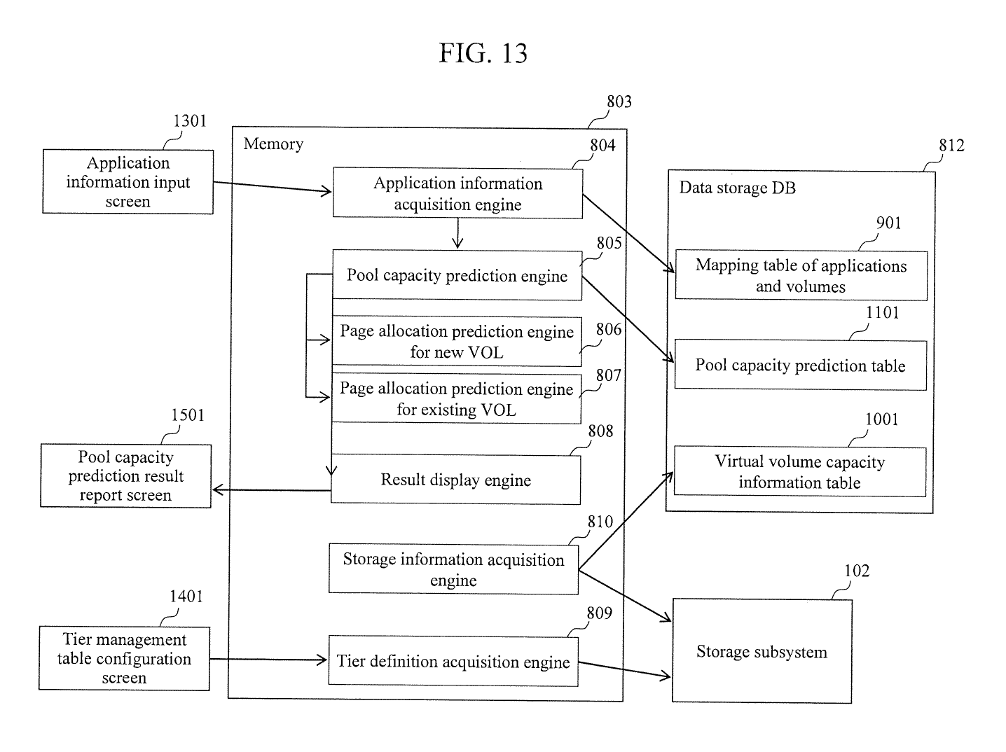

Meanwhile, the management computer 103 predicts the capacity consumption patterns of the VVOL used by the application based on the information of the information of the application to be added designated by the user and the VVOL and executes a process of reporting (outputting) the prediction result. In relation to the process, a summary of the entire system will be described using FIG. 13, particularly the data structure and the processing flow. FIG. 13 is a diagram for explaining an overall summary of the process in the present system.

(i) Process from Input of Information of Application That Should Be Added to Pool Point Prediction Result Output

When information related to an application to be added or an application for which the correspondence of volume is to be changed is inputted from the application information input screen 1301 displayed on the management system 107, the application information acquisition engine 804 stores the input information in the mapping table 901 of applications and volumes.

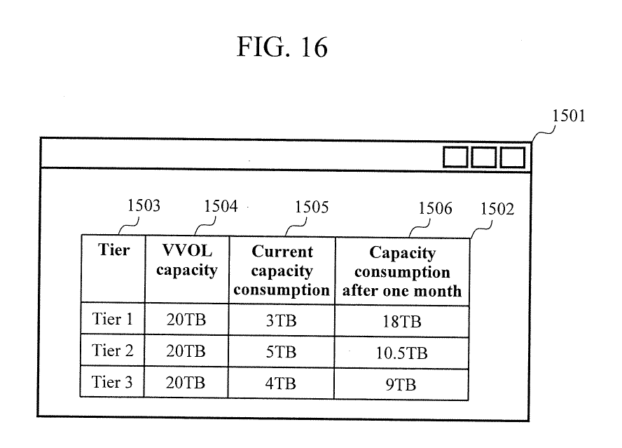

The pool prediction engine 806 then activates the Page allocation prediction engine for new VOL 806 and the Page allocation prediction engine for existing VOL 807. Both engines 896 and 807 execute processes to provide execution results to the pool capacity prediction engine 805. The pool capacity prediction engine 805 that has received the execution result stores the pool capacity prediction result in the pool capacity prediction table 1101 and activates the result display engine 808. The activated result display engine 808 acquires the pool capacity prediction result from the pool capacity prediction table 1101 and displays the result on the pool capacity prediction result report screen 1501 (see FIG. 16).

### (ii) Storage Information Acquisition Process

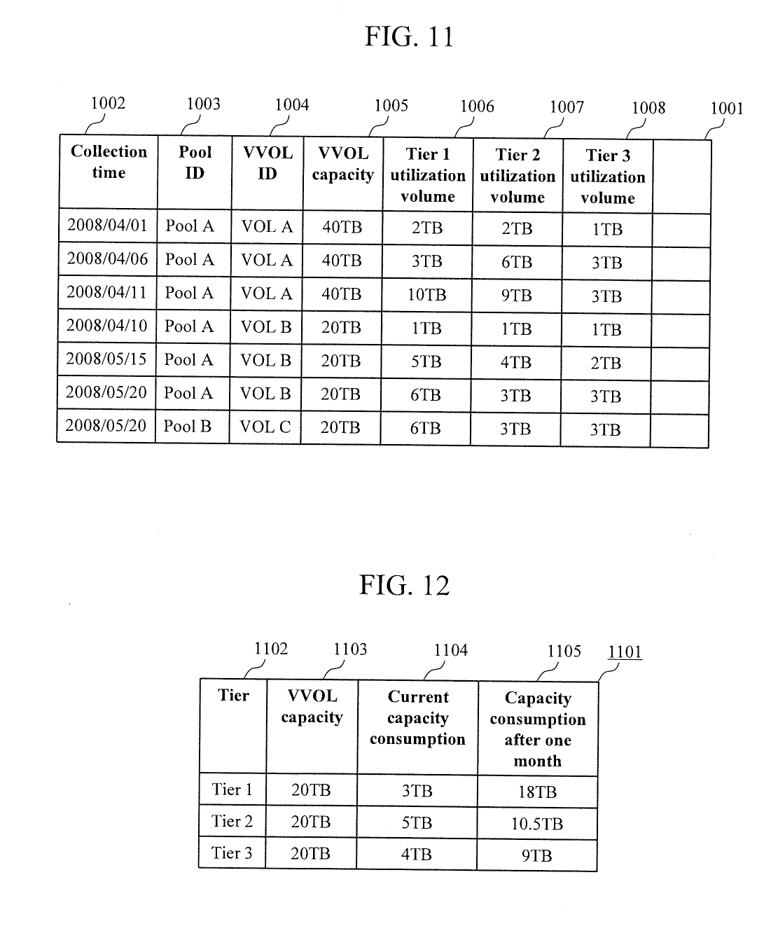

The storage information acquisition engine 810 periodically polls the data in the storage subsystem 102 to acquire the capacity of each virtual volume and stores the information of the capacity in the virtual volume capacity information table 1001 (see FIG. 11).

(iii) Tier Definition Acquisition Process

When the information of the tier configured using the tier management table configuration screen 1401 (see FIG. 15) displayed in the management system 107 is inputted, the tier definition acquisition engine 809 stores the information in the tier management table 310 of the storage subsystem 102.

### <Periodically Executed Tier Rearrangement Process of Storage Subsystem 102>

The management computer 103 periodically instructs the storage subsystem 102 to execute the rearrangement process of the Tiers periodically. For example, the status of allocation of the real areas to the virtual areas in the virtual volume is reviewed every one hour or thirty minutes.

For each virtual area in the virtual volume, the management computer 103 determines whether the number of accesses to the virtual area exceeds the range of the number of accesses corresponding to the tier including the real area allocated to the virtual area. The management system allocates a real area (hereinafter, “real area of transition destination”) in a tier corresponding to a range of the number of accesses, in which the number of accesses to the virtual area falls within, to the virtual area determined to be out of the range as a result of the determination, in place of the real area (hereinafter, “real area of transition source”) allocated to the virtual area. Specifically, the management computer 103 instructs the storage subsystem 102 to move the data of the real area of transition source to the real area of transition destination. The number of accesses to the virtual area denotes the number of processed access requests after designating all or part of the target virtual area as an address range.

### <Rearrangement Process>

FIG. 17 is a flow chart for explaining details of the rearrangement process. The rearrangement process is a process applied to a virtual volume (hereinafter, “target VVOL” in the description of FIG. 17) registered in the VVOLID 601 of the VVOL management table 311.

### (Processing Content of Step 1700)

The management computer 103 requests the storage control program 307 of the storage subsystem 102 for the execution of the rearrangement process every certain time (for example, every thirty minutes or one hour).

### (Processing Content of Step 1701)

The storage control program 307 acquires the value of the number of accesses 604 of each VVOLID 601 registered in the VVOL management table 311, compares the value of the number of accesses 604 of each virtual area and the range of allowable number of accesses 703 of the tier management table 310 to determine whether the arrangement location is appropriate, and specifies the tier ID 701. As a result, the recorded tier ID may be the same as or different from the tier ID of the tier including the real area allocated to the virtual area.

### (Repetition Process)

Next, the storage control program 307 applies a process of steps 1703 to 1708 to all virtual areas acquired in step 1701.

### (Processing Content of Step 1703)

The storage control program 307 determines whether the ID of the tier (will be called “target area arrangement source tier”) corresponding to the real area allocated to the current target virtual area and the value of the rearrangement determination result specified in step 1701 match. Specifically, the storage control program 307 specifies the ID 501 of the RAID group including the real area based on the ID 603 of the real area allocated to the target virtual area to specify the tier ID 701 corresponding to the performance requirement 702 met by the device type 402 and/or the RAID level 403 corresponding to the RAID group. Whether the specified tier ID 701 and the value of the rearrangement determination result specified in step 1701 match is determined.

If the target area arrangement source tier is a tier that should be arranged (Yes in step 1703), the data transition of the target virtual area is not necessary, and the process for the target virtual area ends. On the other hand, if the target area arrangement source tier is not a tier that should be arranged (No in step 1703), the process moves to step 1704.

### (Processing Content of Step 1704)

The storage control program 307 determines whether there is an unallocated real area in the tier (will be called “target area arrangement destination tier”) indicated by the tier ID of the rearrangement determination result specified in step 1701 based on the real area management table 309.

If there is a space in the tier that should be arranged (Yes in step 1704), the process moves to step 1706. If there is no space in the tier that should be arranged (No in step 1704), the process moves to step 1705.

### (Processing Content of Step 1706)

The storage control program 307 allocates an unallocated real area (will be called “data transition destination real area”) in the target area arrangement destination tier in place of the real area (will be called “data transition source real area”) currently allocated to the target virtual area. Specifically, the storage control program 307 updates the value of the allocation status 309 corresponding to the data transition source real area of the real area management table 309 to “unallocated” and updates the value of the allocation status 309 corresponding to the data transition destination real area to “allocated”. In the present embodiment, for example, the real areas and the virtual areas are managed to be separated by the same capacity, and the capacities of the transition source and the transition destination do not have to be taken into consideration.

The storage control program 307 also updates the value of the real area ID 603 corresponding to the target virtual area in the VVOL management table 311 to the ID of the data transition destination real area. The storage control program 307 also moves the data from the data transition source real area to the data transition destination real area.

The performance of other virtual volumes may be affected if the process of step 1706 is executed. For example, all unallocated real areas in a tier with high performance may be used up in the rearrangement process of a virtual volume as a result of the process of step 1706. In this case, the unallocated real areas in the tier cannot be allocated to the virtual area in the virtual volume to which the rearrangement process will be applied subsequently. Therefore, as in the process of steps 1707 and 1708 described later, if there is a virtual area for which it is determined that the real area in the tier should be allocated, the allocation status and the data are replaced by those of another virtual area to which the real area in the tier is allocated, or a real area of another tier with close performance is allocated. This may affect the performance. To handle the situation, for example, a method can be considered, in which the unallocated real area is not allocated to the virtual area of the target VVOL in the rearrangement process, and optimization of the status of the real area allocation to the virtual area in the target VVOL is realized only by always replacing the virtual area by another virtual area in the target VVOL. The storage control program 307 determines whether to use the unallocated real area in the rearrangement process based on, for example, the number and/or the ratio of the unallocated real areas in each tier. More specifically, even if there are unallocated real areas in the target area arrangement destination tier in the process of step 1704, the storage control program 307 moves not to the process of step 1706, but to the process of step 1705 if the number of the unallocated real areas is smaller than 10% of the number of all real areas in the target area arrangement destination tier.

### (Processing Content of Step 1705)

The storage control program 307 determines whether there is a real area in which the data can replace the data of the real area allocated to the target virtual area. Specifically, the storage control program 307 determines whether there is a real area among the allocated real areas in the target area arrangement destination tier, in which the tier ID of the rearrangement determination result that corresponds to the virtual area for which the real area is allocated and that is specified in step 1701 matches the tier ID of the target area arrangement source tier.

If there is a replaceable real area (Yes in step 1705), the process moves to step 1707. If there is no replaceable real area (No in step 1705), the process moves to step 1708.

### (Processing Content of Step 1707)

The storage control program 307 switches the status of allocation to the virtual area between the real area (hereinafter, called “target real area 1” in the description of step 1707) allocated to the target virtual area and the allocated real area (hereinafter, called “target real area 2” in the description of step 1707) included in the target area arrangement destination tier. Specifically, in the real area ID 603 of the VVOL management table 311, the storage control program 307 stores the ID of the target real area 2 in a location where the ID of the target real area 1 is stored and stores the ID of the target real area 1 in a location where the ID of the target real area 2 is stored. The storage control program 307 also switches the data between the target real area 1 and the target real area 2. For example, the storage control program 307 executes the following process to realize the switch of the data. A cache memory area in the following process may be an unallocated real area included in the storage subsystem 102.

Procedure 1: the storage control program 307 writes the data in the target real area 1 to the cache memory area.

Procedure 2: the storage control program 307 writes the data in the target real area 2 to the cache memory area.

Procedure 3: the storage control program 307 writes the data of the target real area 1 from the cache memory area to the target real area 2.

Procedure 4: the storage control program 307 writes the data of the target real area 2 from the cache memory area to the target real area 1.

### (Processing Content of Step 1708)

The storage control program 307 moves the data in the real area allocated to the target virtual area to the unallocated real area in the tier with the performance closest to the performance of the target tier. The storage control program 307 also updates the VVOL management table 311 and the real area management table 309.

### <Summary of Overall Process Executed by Management Computer 103>

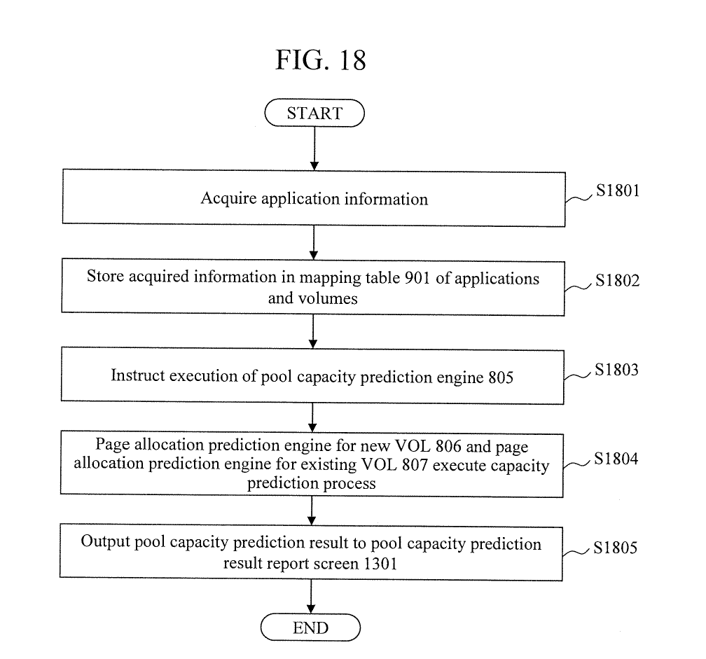

FIG. 18 is a flow chart for explaining a summary of the overall process executed by the management computer 103 in the present embodiment.

### (Step 1801)

When the user (manager) inputs information of a host identifier 1302, a Storage identifier 1303, a PoolID 1304, a VVOLID 1305, a VVOLSIZE 1306, a VVOLSIZE 1307, the application name 1307, the application type 1308, and the prediction period 1309 in the application information input screen 1301 (see FIG. 14) to launch an execution 1310, the application information acquisition engine 804 acquires the inputted information. Although the pool capacity prediction process may be executed immediately when the execution button 1310 is pressed after the input of information of a newly added application or an application for which the usage (used volume) will be changed, the pool capacity prediction process may be executed after a period designated by the user. In that case, the virtual volume to be allocated needs to be reserved to prevent the other users from using the virtual volume. Not only when the application is newly added or changed as described above, the pool capacity after deletion may be predicted after deleting the application. Hereinafter, processes associated with the application information input (S1801) when the application is added and when the application is deleted will be described.

(i) Case of Adding Application: Addition of Virtual Volume Associated with Application Addition Instruction

The input screen of the application information is as shown in FIG. 14. Information is added to the mapping table 901 and the virtual volume capacity information table 1001 when an application is added. More specifically, the application information acquisition engine 804 adds lines to the application name 902, the application type 903, and the VVOLID 904 of the mapping table 901 of applications and volumes based on the application name 1302, the application type 1303, and the VVOLID 1304 inputted to the application addition screen 1301.

The storage information acquisition engine 810 adds lines to the pool ID 1003 and the VVOLID 1004 of the virtual volume capacity information table 1001 based on the VVOLID 1304 and the POOLID 1305.

Based on the VVOLID 1304 and through the management network 106, the management computer 103 instructs the storage control program 307 in the storage subsystem 102 to change the allocation status 504 of the real area management table 309 corresponding to a VVOLID 2004 to “allocated”. More specifically, the storage control program 307 that has received the instruction acquires the VVOLLBA range 602 and the real area ID 603, in which the VVOLID 601 of the VVOL management table 311 and the VVOLID 2004 match, and changes the allocation status 504, in which the real area ID 502 and the RGLBA range 503 of the real area management table 309 match the VVOLLBA range 602 and the real area ID 603, to “allocated”.

(ii) Case of Deleting Application: Deletion of Virtual Volume Associated with Application Deletion

As described, in addition to the new addition of an application, deletion of an allocated virtual volume associated with the deletion of an application is also possible in the present embodiment. Improvement in the accuracy of the utilization volume of each Tier of the target pool and release of unnecessary areas can be expected as a result of deleting the allocated virtual volume.

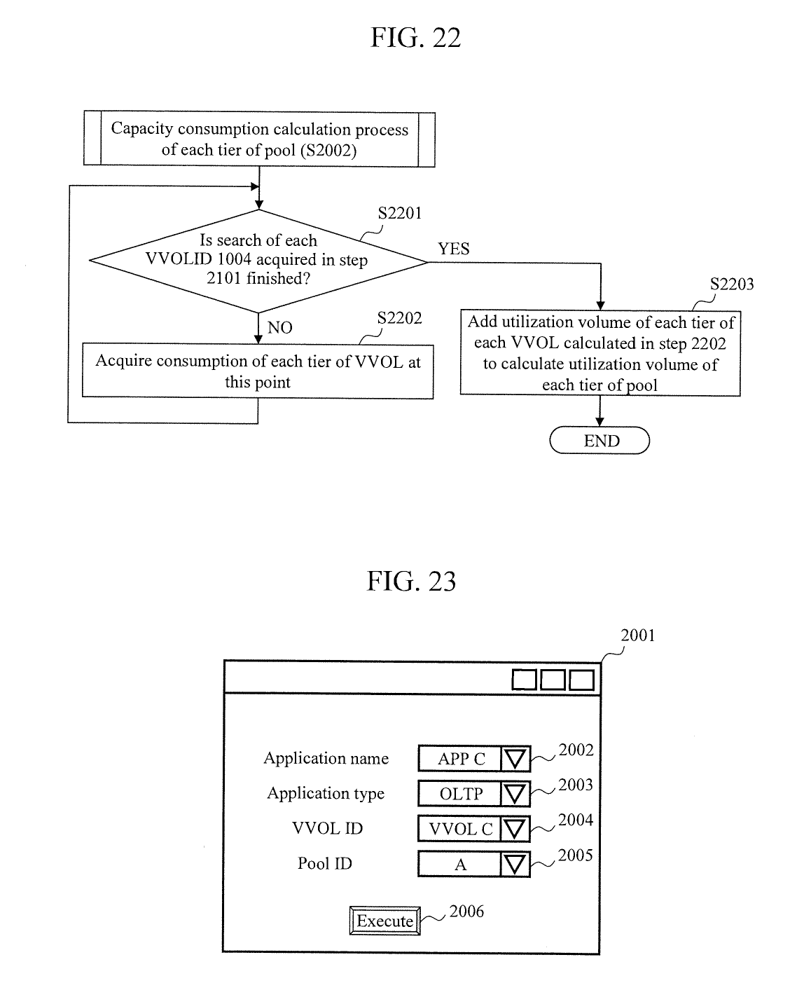

In the case of deleting application, deletion of the virtual volume allocated to the application is realized. Specifically, an application deletion screen 2001 is created as shown in FIG. 23, an application name 2002, an application type 2003, the VVOLID 2004, and a POOLID 2005 of the deletion target are inputted, and an execution 2006 is launched.

The application information acquisition engine 804 deletes lines of the application name 902, the application type 903, and the VVOLID 904 of the mapping table 901 of applications and volumes based on the application name 2002, the application type 2003, and the VVOLID 2004 inputted to the application deletion screen 2001.

The storage information acquisition engine 810 deletes all lines of the pool ID 1003 and the VVOLID 1004 of the virtual volume capacity information table 1001 based on the VVOLID 2004 and the POOLID 2005.

Based on the VVOLID 2004 and through the management network 106, the management computer 103 instructs the storage control program 307 in the storage subsystem 102 to change the allocation status 504 of the real area management table 309 corresponding to the VVOLID 2004 to “unallocated”. More specifically, the control program 307 that has received the instruction acquires the VVOLLBA range 602 and the real area ID 603, in which the VVOLID 601 of the VVOL management table 311 and the VVOLID 2004 match, and changes the allocation status 504, in which the real area ID 502 and the RGLBA range 503 of the real area management table 309 match the VVOLLBA 602 and the real area ID 603, to “unallocated”.

### (Step 1602)

The application information acquisition engine 804 stores the information of the application name 1307, the application type 1308, and the VVOLID 1305 acquired from the application information input screen 1301 in the mapping table 901 of applications and volumes in the data storage DB 812 of the storage device 811.

### (Step 1603)

The application information acquisition engine 804 instructs the pool capacity prediction engine 805 to execute the prediction process based on the input of the information of the VVOLSIZE 1306, the prediction period 1309, the application type 1308, and the POOLID 1304 acquired in step 1601.

### (Step 1804)

The pool capacity prediction engine 805 activates the Page allocation prediction engine for new VOL 806 and the Page allocation prediction engine for existing VOL 807 to obtain input parameters necessary for the prediction of the capacity consumption patterns of the VVOL used by the application.

As the pool capacity prediction engine 805 transfers the VVOLSIZE 1306, the prediction period 1309, and the application type 1308 as parameters to the Page allocation prediction engine for new VOL 806 upon activation, the Page allocation prediction engine for new VOL 806 acquires the capacity consumption of each Tier after the prediction period 1309 for the VVOLSIZE 1305 to be allocated. Specific processing content will be described later.

The Page allocation prediction engine for existing VOL 807 predicts the influence on the existing pool in association with the addition of VVOL for the pool forming the VVOL to be allocated. The Page allocation prediction engine for existing VOL 807 receives the POOLID 1304 and the prediction period 1309 as parameters upon the activation to acquire the predicted capacity consumption of each Tier of the pool after the prediction period 1309 in the POOLID 1304. Specific processing content will be described later. When the deletion of the application is instructed from the management computer 103, the application to be deleted is deleted in response to the instruction as described above, and the corresponding virtual volume is changed to “unallocated”. The total capacity of consumption of all existing applications excluding the application to be deleted is predicted. This is because data may remain in the high-performance Tier 1 or the like after the deletion of the application, and the resources may be wasted. Therefore, the prediction process by the Page allocation prediction engine for new VOL 806 is not executed when the deletion of the application is instructed. However, in a case such as when the application is temporarily deleted (terminated), the consumed capacity of other existing applications may be predicted while leaving the data in the virtual volume. When the temporarily terminated application is restored, the Page allocation prediction engine for new VOL 806 may execute the process to predict the consumed capacity after the designated period from the restoration.

The pool capacity prediction engine 805 adds the results obtained from the prediction engines 806 and 807 and stores the result in the pool capacity prediction table 1101. Specifically, the pool capacity prediction engine 805 adds the result predicted by the Page allocation prediction engine for new VOL 806 to the predicted capacity consumption of each Tier of the pool after the prediction period 1309 calculated by the Page allocation prediction engine for existing VOL 807 and stores the calculation result to a capacity consumption after one month 1105. The pool capacity prediction engine 805 also stores, in a current capacity consumption 1104, the capacity consumption of each Tier of the pool at this point calculated in step 2212 by the Page allocation prediction engine for existing VOL 807. The pool capacity prediction engine 805 also stores the VVOLSIZE 1306 of the VVOL to be allocated in a VVOL capacity 1103.

### (Step 1805)

The pool capacity prediction engine 805 activates the result display engine 808. The result display engine 808 outputs the data of the pool capacity prediction table 1101 to the pool capacity prediction result report screen 1301.

The price of each Tier generated upon the purchase of the Tier may be reported. In this case, the pool capacity prediction engine 805 and the result display engine 808 can be expanded to report the price necessary for the purchase of each Tier along with the prediction of the capacity consumption.

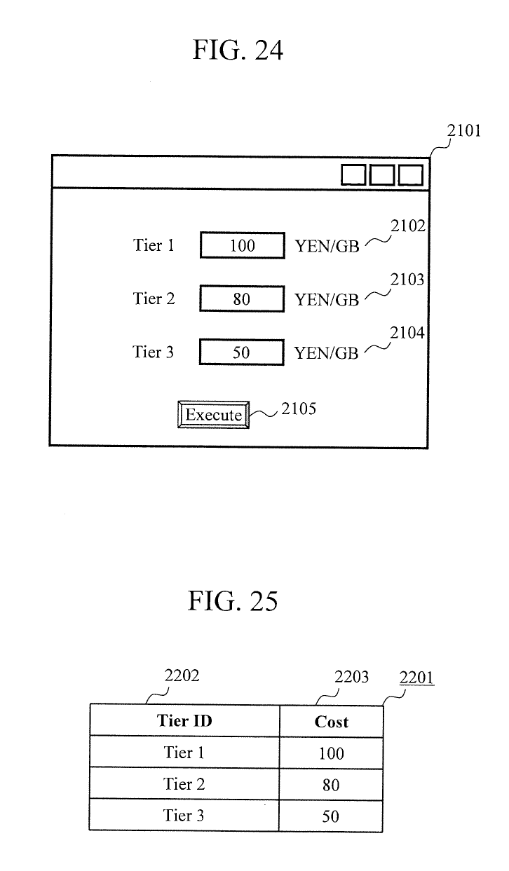

As shown in FIG. 24, a charge configuration screen 2101 of each Tier is created to configure the cost of each Tier. Cost inputs 2102 to 2104 of each Tier are executed on the charge configuration screen 2101 of each Tier, and an execution 2105 is pressed.

In this case, the pool capacity prediction engine 805 stores the information inputted on the charge configuration screen 2101 of each Tier in a charge management table 2201 of each Tier (see FIG. 25). Specifically, the pool capacity prediction engine 805 stores the cost inputs 2102 to 2104 of each Tier in the charge management table 2201 of each Tier. In the calculation of data, the pool capacity prediction engine 805 acquires the data of each Tier from the capacity consumption after one month 1105 of the pool capacity prediction table 1101 after the execution of the process of step 1804 and stores a value obtained by multiplying the data by the data of Cost 2203 of the charge management table 2201 of each Tier in the pool capacity prediction table 1101.

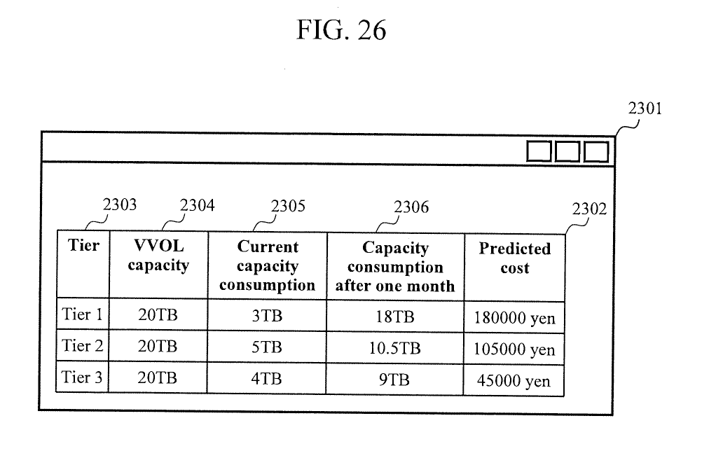

Subsequently, the pool capacity prediction engine 805 causes the result display engine 808 to output the data of the pool capacity prediction table 1101 to the pool capacity prediction result report screen 2301 in step 1805. The screen drawing result in this case is displayed as shown in FIG. 26. The difference between FIGS. 26 and 16 is that a predicted cost 2302 is displayed. Although the cost required to purchase the device when the capacity is insufficient is displayed here, the cost based on the consumed capacity may be displayed in a system in which the fees are charged by the consumed capacity.

<Details of Process of Page allocation prediction engine for new VOL 806>

FIG. 19 is a flow chart for explaining details of the process of the Page allocation prediction engine for new VOL (hereinafter, may also be called “new allocation prediction engine”) 806 during the addition of application.

### (Step 1901)

The new allocation prediction engine 806 acquires the VVOL ID 904 from the mapping table 901 of applications and volumes based on the application type of the VVOL to be allocated to search a VVOL with usage patterns similar to the VVOL to be allocated. More specifically, an existing application similar to the type of the application to be added is specified. Here, “similar” is a concept including the “same”. For example, if the application to be added is a search engine, the same search engine is selected if there is already the same search engine, and another search engine is selected if there is another search engine that is not the same. If there are applications of a plurality of similar types, one of the applications may be selected to use the patterns at the start of the installation for prediction, or a plurality of applications may be selected to average the patterns at the start of the installation.

### (Step 1902)

The new allocation prediction engine 806 applies a process of steps 1903 to 1906 to the entire list of the VVOLIDs 904 of the similar usage acquired in step 1901. The process moves to step 1907 if the process is applied to the entire list.

### (Step 1903)

Based on the virtual volume capacity information table 1001, the new allocation prediction engine 806 assumes the oldest time of the start of the collection of the currently targeted VVOL of the similar usage as operation start time. The operation start time can be arbitrarily configured in the virtual volume capacity information table 1001 unless information of a predetermined period before the latest time is used. If the use status at the start of the installation of the application of the similar type is particularly peculiar compared to the operation schedule of the added new application or the like, a period in which the use status of the similar application is stable may be selected for use in the prediction process.

### (Step 1904)

The new allocation prediction engine 806 acquires, from the virtual volume capacity information table 1001, data from the time acquired in step 1903 (operation start time) to the prediction period designated by the user (for example, one month).

### (Step 1905)

The new allocation prediction engine 806 executes the Tier 0 utilization volume 1006÷the VVOL capacity 1005, the Tier 1 utilization volume 1007÷the VVOL capacity 1005, and the Tier 2 utilization volume 1008÷the VVOL capacity 1005 for each of the execution results of step 1904 to calculate, for each Tier, the consumption rate relative to the allocation capacity of the VVOL.

### (Step 1906)

To estimate, as a safety factor, the maximum value of the consumption rate relative to the VVOL allocation capacity of each Tier calculated in step 1905 in the similar application, the new allocation prediction engine 806 sets the maximum value as a possible predicted value if the maximum value at the moment is calculated and holds the value as a set of the utilization volumes 1006 to 1008 of Tier and the VVOL capacity 1005. More specifically, in step 1906, a process of finding out the Tier utilization volume and the VVOL capacity with the maximum capacity consumption within the designated period from the operation start time is ultimately executed.

### (Step 1907)

After verification of all target VVOLs of the similar usage, the new allocation prediction engine 806 calculates the consumption rate relative to the VVOL allocation capacity for each Tier in relation to the set of possible values. The process is for applying a similar computation as in step 1905 to the possible combination (the Tier utilization volume 1006 and the VVOL capacity 1005) with the maximum value. Although the same computation does not have to be executed if the computation result is held, a case in which the computation result is not held is assumed here.

### (Step 1908)

The new allocation prediction engine 806 multiplies the value calculated in step 1907 by the VVOL to be newly allocated designated by the user. In this way, the predicted capacity consumption of each Tier after the designated period relative to the VVOL designated by the user can be calculated.

### (Step 1909)

The new allocation prediction engine 806 returns the value calculated in step 1908 to the pool capacity prediction engine 805 as a predicted value of the pool capacity consumed by the added application.

### <Details of Process of Page Allocation Prediction Engine for Existing VOL 807>

FIG. 20 is a flow chart for explaining a summary of processing by the Page allocation prediction engine for existing VOL 807. The Page allocation prediction engine for existing VOL (hereinafter, may also be called “existing allocation prediction engine”) 807 returns the value calculated in a predicted capacity consumption calculation process of each Tier of pool (step 2001) and the value calculated in a capacity consumption calculation process of each Tier of pool (step 2002) to the pool capacity prediction engine 805. Hereinafter, details of steps 2001 and 2002 will be described.

### (i) Details of Predicted Capacity Consumption Calculation Process of Each Tier of Pool (S2001)

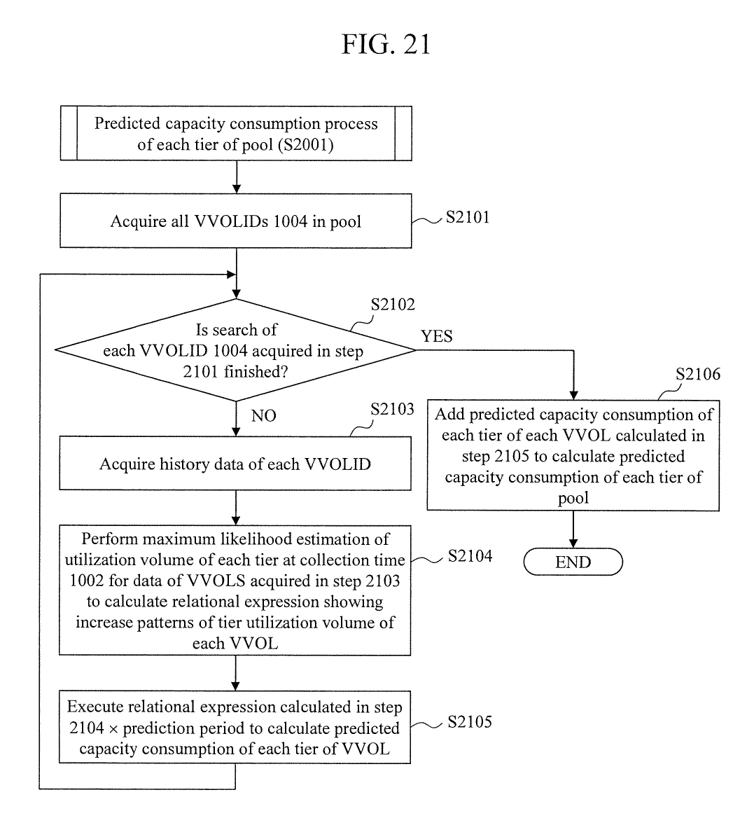

FIG. 21 is a flow chart for explaining details of the predicted capacity consumption calculation process of each Tier of pool (step 2001).

### (Step 2101)

The existing allocation prediction engine 807 acquires a list of all VVOLs of the POOLIDs 1304 inputted from the application information input screen 1301. A process of S2103 to 52105 is applied to the acquired VVOLs.

### (Step 2102)

The existing allocation prediction engine 807 determines whether the process (S2103 to S2105) is applied to all VVOLIDs 1004 acquired in step 2101. If the process is completed, the process moves to step 2106.

### (Step 2103)

The existing allocation prediction engine 807 acquires history data for each VVOL. Although all data in the past is acquired here, the user (manager) may designate a range (period) of data to be acquired to use the data in the designated period, or data in a fixed period may be used.

### (Step 2104)

The existing allocation prediction engine 807 applies maximum likelihood estimation (for example, least squares method is used) of utilization volume of each Tier at every collection time 1002 to the data acquired in step 2103 to calculate a relational expression indicating the increase patterns of the utilization volume of each Tier of VVOL.

### (Step 1808)

The existing allocation prediction engine 807 multiplies the relational expression calculated in step 2104 by the prediction period 1309 that is inputted in the application information input screen 1301 and that is designated by the user to calculate a prediction of the capacity consumption of each Tier of VVOL. Therefore, the capacity consumption after the designated period is predicted based on past statistical data.

### (Step 1809)

The existing allocation prediction engine 807 adds the predicted values of the capacity consumption of each Tier of each VVOL calculated in step 2105 to calculate the predicted capacity consumption of each Tier of pool.

### (ii) Details of Capacity Consumption Calculation Process of Each Tier of Pool (S2002)

FIG. 22 is a flow chart for explaining details of the capacity consumption calculation process of each Tier of pool (step S2002).

### (Step 2201)

The existing allocation prediction engine 807 determines whether the process of step 2202 is completed for all VVOLIDs 1004 acquired in step 2101. If the process of 52202 is completed, the process moves to step 2203.

### (Step 2202)

The existing allocation prediction engine 807 acquires consumption of each Tier of VVOL at the current time. If there is no current data in a precise sense, latest data may be used.

### (Step 1812)

The existing allocation prediction engine 807 adds the capacity consumptions (current capacities) of each Tier of each VVOL calculated in step 2202 to calculate the capacity consumption of each Tier of pool.

### <Modified Example>

(i) Re-prediction of Volume Consumption Associated with Characteristic Change of Application

Although the allocation of a new virtual volume associated with the addition of an application is mainly illustrated in the embodiment, the present invention can be expanded to re-predict the capacity consumption in accordance with the characteristic change of the existing application. The “characteristic change” denotes a change in the usage of the virtual volume once allocated to the application, such as when a virtual volume (VVOL) allocated first to OLTP is allocated to another application.

In another example of the “characteristic change”, the characteristics may change along with the operation depending on the application. More specifically, an operational application may be characterized in that although there are usually few accesses, the accesses increase in a specific period, such as the end of a fiscal year or the end of a term, and the number of accesses becomes close to that to the OLTP.

The present invention can be applied to such a case to execute periodic capacity predictions in consideration of the changes in the application characteristics. Specifically, in the execution of step 1801 (FIG. 18), the user (manager) changes the application type 1308 (FIG. 14), inputs the remaining capacity of the allocated virtual volume to the VVOLSIZE 1307, inputs information as in step 1802 to the application information input screen 1301, and launches the execution 1310. Subsequently, the same process as the process executed by the management computer 103 in the present embodiment is executed. In this way, the process of the new addition of application can be applied even if the characteristics of the existing application are changed. As a result, the capacity consumption after the change in the characteristics of the application can be predicted.

### (ii) Prediction of Volume Consumption in LVM Environment

Depending on the application, there is an environment in which an LVM (Logical Volume Manager) function and the like provided by an OS on a server is used to group the allocation logical volumes to show and allocate one virtual volume to the application. In such an environment, the concept of the present invention can be applied (extended) to predict a future consumption from the sum of the capacity consumptions of individual logical volumes allocated to the application to predict the capacity consumption of the LVM environment. More specifically, one group (comprising a plurality of VVOLs) is allocated to the application in the LVM function, and the capacity consumption prediction of the group can be shown by adding the capacity consumption predictions of the constituent VVOLs. In the environment for realizing the LVM function, the volume allocated to the application may be a VVOL cut out from a different pool. Therefore, in such a case, the capacity needs to be predicted not only from one pool, but also from relevant pools to predict the consumed capacity of the entire group. The information input screen and the process of step 1908 need to be extended as follows to apply the present invention to the environment.

First, as for the information input screen, a list is added to allow inputting information of a plurality of volumes to the VVOLID 1305 and the VVOLSIZE 1307 of the application information input screen 1301 in order to allow inputting the information of the individual virtual volumes allocated to the application. Consequently, the user (manager) inputs the information of all virtual volumes comprising the LVM.

In S1908, the Page allocation prediction engine for new VOL 806 changes the VVOL capacity to be allocated to the sum of all virtual volumes comprising the LVM. More specifically, S1908 is changed to “sum of the ratio of each Tier calculated in step 1907×each VVOL value inputted to the VVOLSIZE 1307 of the application information input screen 1301”.

Subsequently, the same process as the process executed by the management computer 103 in the present embodiment can be executed.

### <Conclusion>

In the present embodiment, when an addition of an application is newly instructed or when a change in the allocation of a virtual volume used by an existing application is instructed, information related to past consumption capacity patterns (for example, patterns of consumed capacity in a predetermined period from the start of the installation of the application) of the virtual volume used by the new application, the allocation change target application, or the application with the same or similar application type is acquired in response to the instruction. The consumed capacity in the virtual volume to be allocated is predicted based on the information related to the acquired consumption capacity patterns. This allows recognizing the depletion timing of the capacity (for example, capacity allocated to the pool) associated with the addition of application or the change in the allocation of volume. The reason that the information of the consumed capacity patterns from the start of the installation of the application is acquired is to more accurately recognize the patterns of the consumed capacity associated with the addition or the allocation change.

In the storage subsystem, one or more physical storage devices form a tier. The virtual volume comprises one or more tiers and corresponds to the pool associated with the target of direct access by the host computer. In the virtual volume, the consumed capacity (utilization volume) is managed tier by tier (see FIG. 11). To predict the consumed capacity in the virtual volume to be allocated, information related to the past utilization volumes of the allocation areas in one or more tiers forming the virtual volume is used. In this way, the timing of the consumption capacity depletion of pool can be more accurately recognized when the pool comprises a combination of disks with different physical characteristics. Therefore, the system can handle an extended operation of Thin Provisioning.

Furthermore, data related to the past consumed capacity in the virtual volumes used by all existing applications (without change in the allocation status of virtual volume) other than the newly added application and the like is acquired. Based on the data, the maximum likelihood estimation method (for example, least squares method) is used to predict the consumed capacity after the designated prediction period in the virtual volumes used by all existing applications. The predicted consumed capacity of the existing applications and the predicted consumed capacity in the virtual volume to be allocated to the newly added application and the like are added and outputted (displayed or printed out). In this way, the patterns of the consumed capacity of the existing applications can be taken into consideration to present the prediction information of the consumed capacity of the entire system, and the user (manager) can recognize the timing of adding the physical storage device.

The cost required in the future is also presented in addition to the presentation of the predicted consumed capacity. As a result, the user (manager) can efficiently operate the system in consideration of the cost.

If deletion of a virtual volume is instructed in association with the deletion of an application, the application to be deleted is excluded to compute the overall predicted consumed capacity. In this case, the Page allocation prediction engine for existing VOL 807 is used to predict the consumed capacity. As a result, how much the securing of the capacity in association with the application deletion is effective can be determined. Furthermore, although the resource is wasted if the data remains in the high-performance Tier 1 or the like after the deletion of the application, such a situation can be prevented.

The present invention is not limited to the embodiment as it is, and constituent elements can be changed in the execution stage without departing from the scope of the present invention to embody the present invention. Appropriate combinations of a plurality of constituent elements disclosed in the embodiment can form various inventions. For example, some constituent elements may be deleted from all constituent elements shown in the embodiment. Furthermore, constituent elements across different embodiments can be appropriately combined.

Part or all of the configurations, functions, processing parts, processing sections, and the like shown in the embodiment may be realized by hardware, such as by designing the hardware by an integrated circuit. A processor may interpret and execute programs for realizing the functions to realize the configurations, functions, and the like by software. The information of the programs, tables, files, and the like for realizing the functions and the like may be stored in a recording or storage device, such as a memory, a hard disk and an SSD (Solid State Drive), or in a recording or storage medium, such as an IC card, an SD card, and a DVD.

Furthermore, control lines and information lines considered necessary for the description are illustrated in the embodiment, and all control lines and information lines in products may not be illustrated. All configurations may be interconnected.

### REFERENCE SIGNS LIST

100 computer system
101 host computer
102 storage subsystem
103 management computer
104 Web browser computer
105 storage area network
106 management network
107 management system

1. A computer system comprising:
a storage subsystem comprising one or more physical storage devices; and
a management system that manages the storage subsystem,
wherein the storage subsystem provides storage areas of the physical storage devices to a host computer as a virtual volume, and
wherein the management system responds to an input instruction of allocation of the virtual volume that should be used by an application to acquire information related to past consumption capacity patterns of a virtual volume used by an application of the same or similar application type as the application and predicts a consumed capacity in the virtual volume to be allocated based on the information related to the consumption capacity patterns.

2. A computer system according to claim 1,
wherein the input instruction includes an instruction of newly adding an application or an instruction of changing the virtual volume allocated to an existing application, and
wherein the management system responds to the input instruction to execute a process of predicting the consumed capacity in the virtual volume to be allocated.

3. A computer system according to claim 2,
wherein the management system acquires information related to the consumption capacity patterns within a predetermined period from the start of operation of the application of the same or similar type as the newly added application or from the start of operation of the existing application in which the virtual volume allocation is changed and predicts the consumed capacity in the virtual volume to be allocated.

4. A computer system according to claim 3,
wherein the one or more physical storage devices comprise one or more tiers,
wherein the virtual volume comprises the one or more tiers and corresponds to a pool associated with a target directly accessed by the host computer, and
wherein the management system uses information related to past utilization volumes of allocated areas in the one or more tiers comprising the virtual volume to predict the consumed capacity in the virtual volume to be allocated.

5. A computer system according to claim 4,
wherein the management system further acquires information related to past consumed capacities in the virtual volumes used by all existing applications in which the allocation of the virtual volumes are not changed, predicts the consumed capacities after a designated prediction period that are in the virtual volumes used by the all existing applications, and outputs predicted consumed capacities in the virtual volumes to be allocated and predicted consumed capacities of the existing applications together.

6. A computer system according to claim 5,
wherein the system outputs predicted costs of the one or more tiers based on cost configuration information related to costs of the one or more tiers, the predicted consumed capacities in the virtual volumes to be allocated, and the predicted consumed capacities of the existing applications.

7. A computer system according to claim 1,
wherein the management system responds to an input instruction of deletion of an application and deletion of the virtual volume allocated to the application to be deleted, releases the allocation of the virtual volume used by the application to be deleted, acquires information related to past consumed capacities in the virtual volumes used by all existing applications except the application to be deleted, predicts consumed capacities after a designated prediction period that are in the virtual volumes used by all existing applications except the application to be deleted, and outputs the predicted consumptions.

8. A management method of a computer system, the computer system comprising: a storage subsystem that provides storage areas of one or more physical storage devices to a host computer as a virtual volume; and a management system that manages the storage subsystem, the management method comprising:
a step by a processor of the management system acquiring, when allocation of the virtual volume that should be used by an application is instructed, information related to past consumption capacity patterns of a virtual volume used by an application of the same or similar application type as the application; and
a step by the processor predicting a consumed capacity in the virtual volume to be allocated based on the information related to the consumption capacity patterns.

9. A management method according to claim 8,
wherein the instruction includes an instruction of newly adding an application or an instruction of changing the virtual volume allocated to an existing application, and
wherein the processor responds to the input instruction to execute a process of predicting the consumed capacity in the virtual volume to be allocated.

10. A management method according to claim 9,
wherein the processor acquires information related to the consumption capacity patterns within a predetermined period from the start of operation of the application of the same or similar type as the newly added application or from the start of operation of the existing application in which the virtual volume allocation is changed and predicts the consumed capacity in the virtual volume to be allocated.

11. A management method according to claim 10,
wherein the one or more physical storage devices comprise one or more tiers,
wherein the virtual volume comprises the one or more tiers and corresponds to a pool associated with a target directly accessed by the host computer, and
wherein the processor uses information related to past utilization volumes of allocated areas in the one or more tiers comprising the virtual volume to predict the consumed capacity in the virtual volume to be allocated.

12. A management method according to claim 11, further comprising:
a step by the processor acquiring data related to past consumed capacities in the virtual volumes used by all existing applications in which the allocation of the virtual volumes are not changed; and
a step by the processor predicting the consumed capacities after a designated prediction period that are in the virtual volumes used by the all existing applications and outputting predicted consumed capacities in the virtual volumes to be allocated and predicted consumed capacities of the existing applications together.

13. A management method according to claim 12, further comprising
a step by the processor outputting predicted costs of the one or more tiers based on cost configuration information related to costs of the one or more tiers, the predicted consumed capacities in the virtual volumes to be allocated, and the predicted consumed capacities of the existing applications.

14. A management method according to claim 8, further comprising:
a step by the processor releasing, when deletion of an application and deletion of the virtual volume allocated to the application to be deleted are instructed, the allocation of the virtual volume used by the application to be deleted;
a step by the processor acquiring information related to past consumed capacities in the virtual volumes used by all existing applications except the application to be deleted;
a step by the processor predicting consumed capacities after a designated prediction period that are in the virtual volumes used by all existing applications except the application to be deleted; and
a step by the processor outputting the predicted consumptions.

15. A program in a computer system, the computer system comprising: a storage subsystem that provides storage areas of one or more physical storage devices to a host computer as a virtual volume; and a management system that manages the storage subsystem, the program causing a processor of the management system to execute:
a process of responding to an input instruction of allocation of the virtual volume that should be used by an application to acquire information related to past consumption capacity patterns of a virtual volume used by an application of the same or similar application type as the application; and
a process of predicting a consumed capacity in the virtual volume to be allocated based on the information related to the consumption capacity patterns.
